(19) United States
(12) Patent Application Publication
(10) Pub. No.: US 2018/0322901 A1
(43) Pub. Date: Nov. 8, 2018

(54) COPYRIGHT CHECKING FOR UPLOADED MEDIA

(71) Applicant: Hey Platforms DMCC, Dubai (AE)

(72) Inventors: Nadim Basha bin Mohamed Al Qubaisi, Dubai (AE); Anthony Webb, Dubai (AE); Anthony Stephen Clarke, Dubai (AE); Darryl Haydn Jones, Dubai (AE)

(21) Appl. No.: 15/585,448

(22) Filed: May 3, 2017

(51) Int. Cl. G11B 20/00; H04H 20/14; G06F 17/30

(52) U.S. Cl. CPC G11B 20/00971; G11B 2020/1062; G06F 17/30542; H04H 20/14

(57) ABSTRACT

A server and website for receiving uploads of music and other media for commercial distribution performs a copyright check for ensuring that an uploaded music track is not in potential conflict with known rights of other entities. A database of audio fingerprints allows comparison of audio data against copyrighted tracks, and a metadata comparison employs fuzzy text matching and metadata comparisons to identify data attributes suggesting a similarity to known copyrighted material. Industry standard metadata, such as ISRC (International Standard Recording Code) identifiers, ID3 tags, and other relevant data such as titles and authorship, considering alternate and similar spellings as well. A comprehensive copyright check and evaluation ensures that possibly infringing media is filtered out and a distribution entity incurs little risk in accepting media uploaded via the media upload website.

### BACKGROUND

Media players are a common and popular addition to mobile devices, as well as other types of computer rendering devices. Internet sites available for download of media, such as music, videos and full length films, are plentiful and growing. Many sites promote media such as music selections on a fee-for-services, while others allow less restrictive access. Newly authored music tracks undergo an intake process for being accepted into distribution sources that provide commercialization of music tracks through relationships with retail media outlets. The distribution sources often rely on longstanding contributors for sourcing new music, and new entries may encounter suspicion as to authenticity.

### SUMMARY

A server and website for receiving uploads of music and other media for commercial distribution performs a copyright check for ensuring that an uploaded music track is not in potential conflict with known rights. A database of audio fingerprints allows comparison of audio data against copyrighted tracks, and a metadata comparison employs fuzzy text matching and metadata comparisons to identify data attributes suggesting a similarity to known copyrighted material, including consideration of alternate and similar spellings as well. Industry standard metadata, such as ISRC (International Standard Recording Code) identifiers, ID3 tags, and other relevant data such as titles and authorship contribute to bibliographic and metadata associated with an audio track. A comprehensive copyright check and evaluation ensures that possibly infringing media is filtered out, such that a distribution entity incurs little risk in accepting media uploaded via the media upload website.

Configurations herein are based, in part, on the observation that musical tracks (tracks) are the atomic unit of sale for most commercialized music. Unfortunately, conventional approaches to music commercialization, particularly for emerging and novice artists, is burdened by a risk of improper usage or ownership by unscrupulous or uninformed users. Music is often protected by copyright, and due to a mix of different sources that are often combined in a marketable track, infringing works may be difficult to discern. Music distributors often establish relationships with authoring entities, and develop a rapport that translates into an acceptable minimal risk of impropriety after a succession of positive experiences. Conversely, it can be difficult for new contributors or artists to “break in” and implore distributors to accept their contributions without a proven reputation.

Accordingly, configurations herein substantially overcome the shortcomings associated with potentially infringing material by providing a mechanism for identifying and enforcing ownership rights by identifying potentially copyright avoidance or infringement by combining a hash-based fingerprint coupled with metadata comparisons to perform a comprehensive check against databases of copyright protected material for identifying potential conflicts. Music tracks uploaded via the disclosed mechanism, therefore, carries assurances of non-infringing material such that music distributors may accept uploads from unknown artists based on the uploads having passed scrutiny under the disclosed mechanism. In other words, the trust level established by the checks for copyrighted material extend to the novice or emerging artists to permit availability of music distribution channels enjoyed by established artists.

When a user uploads audio tracks, there is a tangible possibility of a copyright infringement. The disclosed approach combines multiple existing audio fingerprinting technologies with metadata searches and fuzzy text matching to improve the rate of positive identification of copyright infringing material. The same approach may be employed to discover issues in video or other media using copyright audio checks.

Accordingly, configurations herein substantially overcome the above described shortcomings by providing a method of enforcing or detecting ownership rights by receiving an audio file containing audio data and metadata from a user, and computing an identity token such as a fingerprint operative to designate an existence of copyrighted material in the audio data. A server performs a matching operation with a database of identity tokens computed from audio data of copyrighted music tracks to identify an entry similar to the computed identity token, and also compares the metadata with metadata corresponding to entries in the database. From both the metadata and fingerprint checks, a determination is made, based on the matching operation and metadata comparison, whether the received audio file corresponds to a protected track.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context diagram of a music distribution environment suitable for use with configurations herein;

FIG. 2 is a block diagram of the music upload server in the music distribution environment of FIG. 1;

FIGS. 3A and 3B are a flowchart of music uploads in the environment of FIGS. 1 and 2; and

FIG. 4 shows a decision tree for music uploads in the environment of FIGS. 1 and 2.

### DETAILED DESCRIPTION

Configurations depicted below present example embodiments of the disclosed approach in the form of a music upload server accessible via a public access network such as the Internet. Users access the server via a GUI (Graphical User Interface) for denoting music tracks (songs) for upload via the server and intended for commercial distribution. Any suitable media file, including music, video or still images may be combined or integrated with the track, as is often the case.

Configurations disclosed below are interoperable with existing commercial music distribution channels and practices. Various websites and other outlets provide commercialization through end-user sales, often by network download but also by more traditional physical means such as CD and vinyl. Regardless of the distribution medium, intellectual property rights in the underlying recording persist, and it is in the interest of distribution entity and sales endpoints to remain vigilant and proactive about preventing dissemination of infringing material. Some of the more common services for music procurement include ITUNES®, SPOTIFY® and AMAZON®, the names of which are protected by their respective trademarks, and which will be referred to as example, but alternative points of retail availability are also applicable to treatment as disclosed herein.

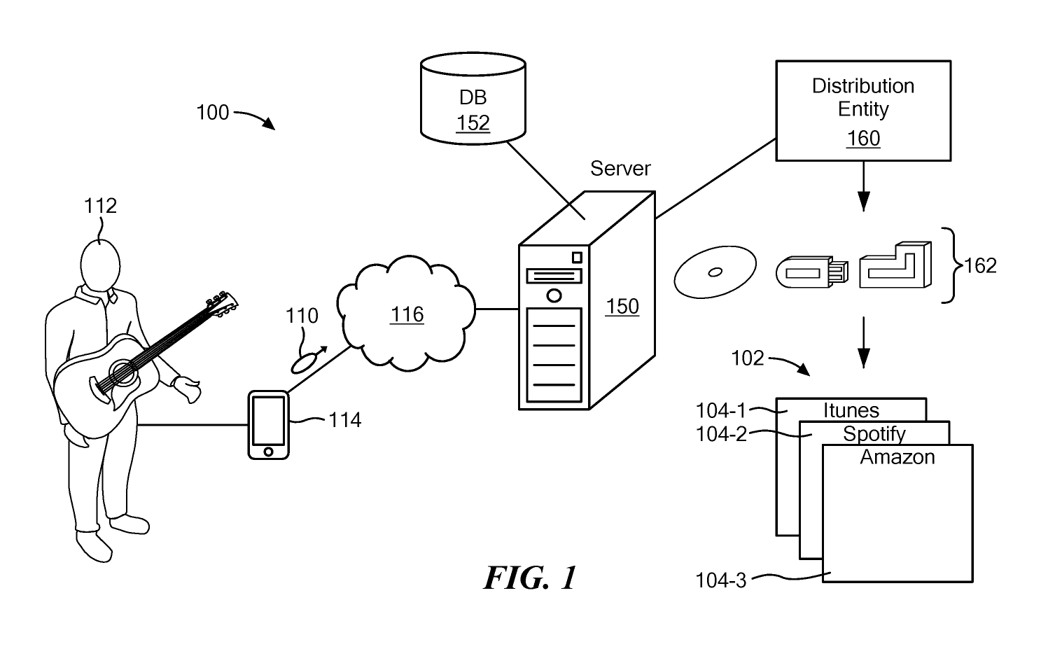

FIG. 1 is a context diagram of a music distribution environment suitable for use with configurations herein. Referring to FIG. 1, in a music distribution environment 100 for receiving audio files 110 intended for retail distribution 102, the method of detecting ownership rights as disclosed herein includes receiving the audio file 110 containing audio data and metadata from a user 112. The user 112 may employ a mobile device 114 or any suitable network conversant device, such as a laptop, tablet, smartphone, or even a full-size desktop computing appliance for uploading via a public access network 116 such as the Internet. A media upload server 150 (server) is operative to receive and evaluate the audio file 110 for potentially infringing material. The server 150 is a network conversant computing device having processor based logic for receiving media and processing the media as disclosed herein. Upon receipt by the server 150, the server computes an identity token operative to designate an existence of copyrighted material in the audio data. The identity token may be a fingerprint based on a hash or other identifier that is unlikely to compute the same value from differing audio data. The server 150 performs a matching operation with a database 152 of identity tokens computed from audio data of copyrighted music tracks to identify an entry similar to the computed identity token, in which the database 152 contains entries of protected tracks aggregated from previously recorded and copyrighted material. The server 150 also compares metadata in the audio file 110 with metadata corresponding to entries in the database 152. The server 150 determines, based on the matching operation and metadata comparison, whether the received audio file 110 corresponds to a protected track that may indicate that the audio file 110 contains copyrighted material. Otherwise, the audio file 110 is deemed to pose little risk of impropriety.

A distributor 160 maintains agreements with various sources for receiving trusted tracks for commercial deployment. The distributor, or distribution entity 160, is a pay for services network resources accessible via a public access network. Once audio files 110 are determined to be free of copyrighted material, media offerings such as CDs, other distribution formats and downloadable files may be undertaken by sales endpoints 104-1 . . . 104-3 (104 generally) such as ITUNES®, SPOTIFY® and AMAZON® sourced by the distribution entity 160. Various sales endpoints are known and readily available. Since the endpoints typically operate with individual songs as the unit of sale and/or download, copyrighted audio data defined herein will be discussed in terms of a track denoting the song, however any suitable level of granularity can apply to a copyright. For example, an entire album or CD is a collection of individual tracks, which may also carry a copyright to the whole or which may be simply be an arbitrary collection of individual tracks.

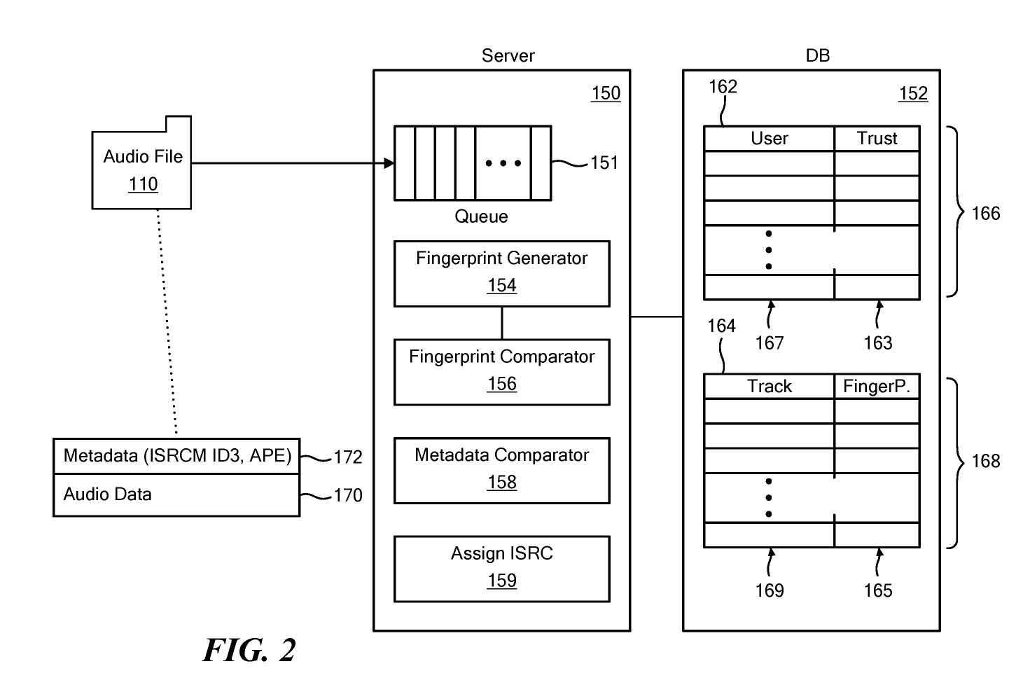

FIG. 2 is a block diagram of the music upload server 150 in the music distribution environment 100 of FIG. 1. Referring to FIGS. 1 and 2, the server 150 includes a song queue 151, a fingerprint generator 154, a fingerprint comparator 156, a metadata comparator 158 and an identifier assigner such as an ISRC assigner 159. The ISRC is a particularly common identifier, which may have been previously assigned or may be assigned by the ISRC assignor 159 at upload. The ISRC is stored in the metadata 172, along with other identifiers indicative of encoding formats and industry standard tags. If a previously assigned ISRC is found to match a known track, an infringement issue exists.

The database 152 includes a user trust table 162, indicative of a trust level of each user who uploads a track, and a fingerprint table 164 having a fingerprint 165 for each known track having a preexisting copyright. The queue 151 receives the audio file 110 from the user 112 for copyright checking and eventual commercial availability. The audio file 110 includes the audio data 170 and metadata 172 about the track contained in the audio data. Metadata includes information such as a title, creator such as an author/artist/composer, a group or band if applicable, encoding information about the format of the audio data, and industry standard identifiers such as an ISRC.

In operation, any suitable rendering format may be employed as the audio file. For example, the audio file may further comprise a video file including an audio portion defining the audio data. While fingerprinting of the audio involves a hash function over the encoded data, similar approaches could be applied to video or other multimedia data.

The server 150 is operable for receiving a plurality of audio files 110, and each audio file has an uploading user 112, in which the audio data 170 in the audio file 110 is purported to be owned by the uploading user 110. The owning “user” could, of course, be an agent of the copyright owner, or a member of a music group or entity that actually maintains legal ownership. Generally, the user is representing that no other party not in privity with the uploading user maintains ownership rights to the audio data, and that the user is authorized to upload the audio file 110 for commercial purposes.

The server 150 stores the audio file 110 in the queue 151 for invocation of fingerprint and metadata comparisons for determining the correspondence to a protected track in the database 152. Queuing manages the computational burden of fingerprint generation and comparison, and the server 150 maintains either near real-time or message based (i.e. email, text) feedback to the user about the copyright evaluation and intake process. The server 150 also maps, upon dequeueing the audio file 110, an encoding format of the audio data 170 for operational compatibility with a distribution entity 160, based on a negative finding of copyright conflicts.

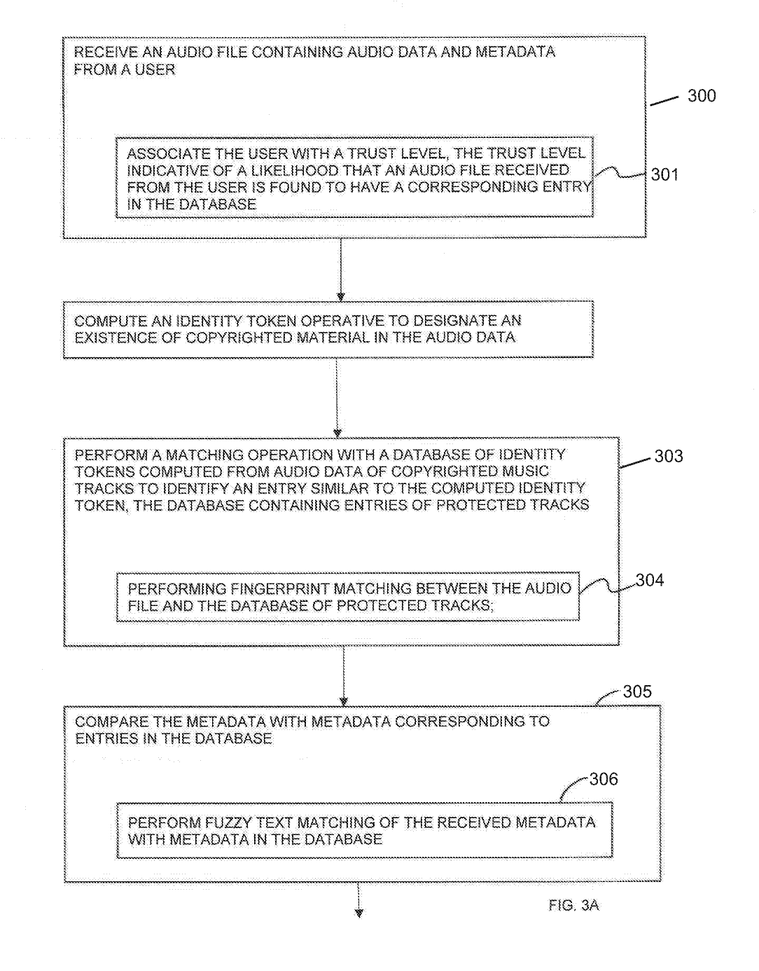

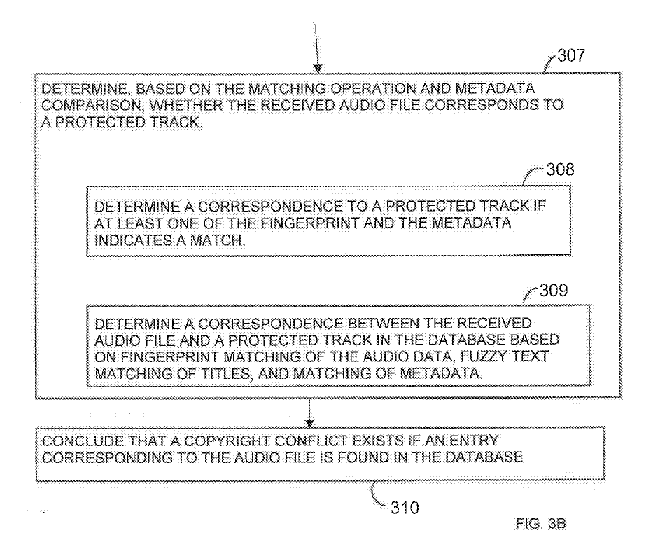

FIGS. 3A and 3B are a flowchart of music uploads in the environment of FIGS. 1 and 2. Referring to FIGS. 1-3B, in the music distribution environment 100 for receiving audio files 110 intended for retail distribution, the method of enforcing ownership rights includes, at step 300, receiving an audio file 110 containing audio data and metadata from a user 112. In contrast to conventional approaches, metadata matching including fuzzy text matching of titles and names will identify alternate spellings, errors, and alias usages for the track to be uploaded. This is further augmented by associating the user 112 with a trust level 163, such that the trust level 163 is indicative of a likelihood that the audio file 110 received from the user 112 is found to have a corresponding entry in the database 152, as depicted at step 301.

The trust table 162 includes a series of entries 166 including the user 167 and corresponding trust level 163. Established users or entities that have a previous history of non-conflicting or findings of non-infringement in previous uploads have a greater trust level than first-time uploaders or those that have uploaded audio files that have not passed the copyright check. Untrusted users will be subject to a manual infringement check if, for example, a metadata check indicates a possible conflict, such as a similar name or entity in the metadata, even though the fingerprint check might not have indicated any impropriety. The user upload therefore further includes computing or updating a trust level 163 of the user 112 from which the audio file 110 was received based on a number and frequency of previous audio file uploads, and a number of previously uploaded audio files found to have a correspondence to a protected track 169 already entered in the database 152.

The server 150 computes an identity token such as a fingerprint operative to designate an existence of copyrighted material in the audio data, as depicted at step 302. The server 150 performs a matching operation with the database 152 of identity tokens computed from audio data of copyrighted music tracks to identify an entry similar to the computed identity token, in which the database 150 containing entries of protected tracks 169, as shown at step 303. This includes performing fingerprint matching between the audio file 110 and the database 152 of protected tracks, as shown at step 304. The server 150 invokes the fingerprint generator 154 to compute a fingerprint or other identity token based on the audio data 170. The fingerprint typically includes computing a hashing function on the audio data 170. Determination of correspondence to a protected track 169 already in the DB 152 includes computing a fingerprint on the audio data 170, performing a lookup in the database 152 to determine if a matching fingerprint is found in the database 152 using the fingerprint comparator 156, and invoking the metadata comparator 158 for comparing the metadata 172 with metadata corresponding to entries 168 in the database 152, as disclosed at step 305. The metadata comparator 172 performs fuzzy text matching of the received metadata with metadata in the database, as depicted at step 306. This includes performing comparisons of the title based on fuzzy text matching to identify a database entry having an alternate title spelling, and comparing the metadata to metadata of entries 168 in the database 152 to identify a similar track or volume arrangement. In this manner, otherwise infringing entities cannot elude checking by making subtle changes to bibliographic information or rearranging track and title information.

In this manner, the server 150 determines, based on the matching operation and metadata comparison, whether the received audio file 110 corresponds to a protected track in the database 152, as disclosed at step 307. In contrast to conventional approaches relying on audio fingerprints alone, the server 150 determines a correspondence to a protected track if at least one of the fingerprint and the metadata indicates a match, as depicted at step 308. Matching includes determining a correspondence between the received audio file 110 and a protected track in the database based on fingerprint matching of the audio data, fuzzy text matching of titles, and matching of metadata, as shown at step 309. The server 150 then concludes that a copyright conflict exists if an entry 168 corresponding to the audio file 110 is found in the database 152.

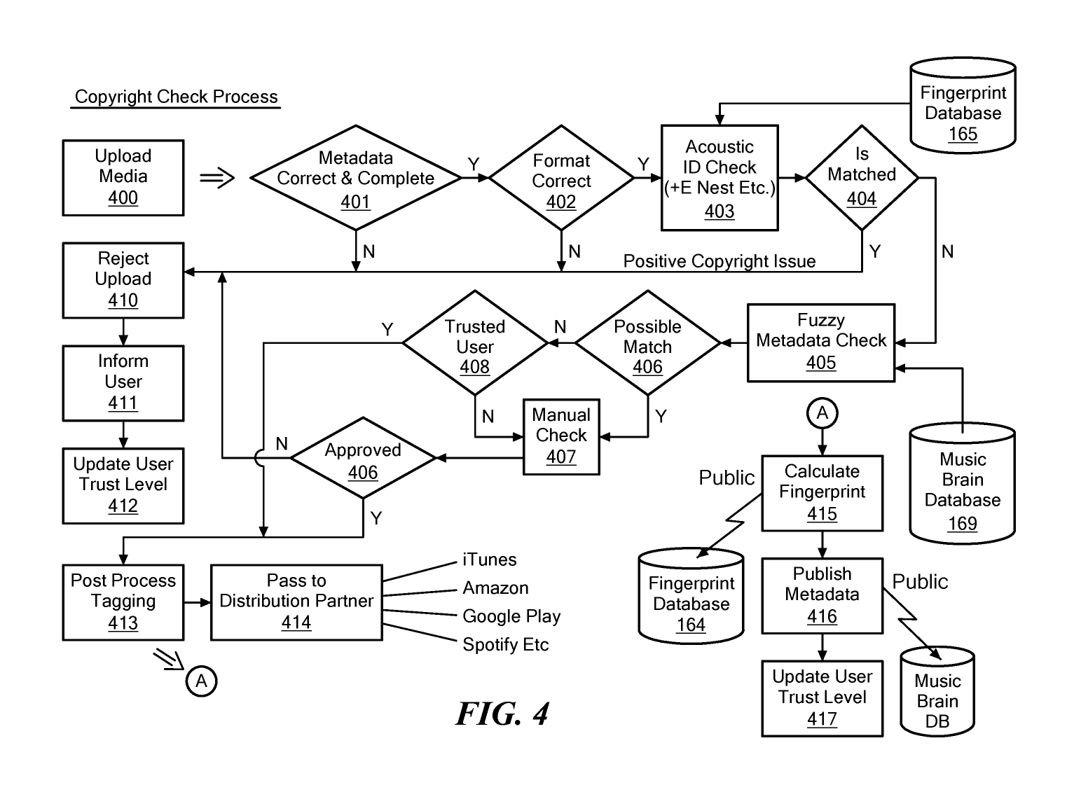

FIG. 4 shows a decision tree for music uploads in the environment of FIGS. 1 and 2. The sequence of FIG. 4 depicts an example process that takes place when a user wishes to sell a track using the disclosed approach. Alternate scenarios may trigger different decision complexities, depending on the degree of similarity in the metadata and the trust level of the user, for example. This decision structure will typically be implemented through a website rendering on the user device 114, via exchanges with the server 150, however any suitable manner of implementation may be employed, such as a local application launched on a user computing device. Generally, the computing resources employed in the fingerprint generation and matching, and the database resources for comparison with known copyrights may be beyond the computing resources of mobile devices.

Referring to FIGS. 1-4, the user 112 fills out a form on the deployed website to provide track data and attaches an audio file 110. The audio file 110 is uploaded to the server 150 at step and placed in the queue 152 for processing. Progress through the queue 151 is relayed to the user through a status shown on the website. In the infringement check stages, if any checks fail, the user is informed of the failure through a status shown on the website and the audio file 110 is not advanced to the distribution entity 160.

In general, the intake process includes receiving, from a graphical user interface (GUI) responsive to the user, an inquiry from the uploading user concerning the audio file 110, prior to determining correspondence to a protected track, verifying the metadata for inclusion of tags expected by the distribution entity, and assigning, if an identifier of the audio track is not defined, the identifier for uniquely identifying the audio track from other entries in the database.

As audio files 110 are pulled from the queue 151 they are initially checked as being in the correct encoding format for upload to the various sales endpoints 104 per the requirements of the distribution entity. The audio file 110 is checked to ensure that it contains all metadata per the requirements of the distribution entity 160 (i.e. all required ID3 tags), as shown at step 401. If the audio file does not contain an ISRC, one is allocated by the ISRC assignor 159 from those provided by the distribution entity 160. If the Audio File does contain an ISRC, or after one is assigned, it is checked for format validity at step 402 and uniqueness. It is possible that the user 112 may enter an existing ISRC belonging to another track; alternatively, there may be a requirement the user use an assigned ISRC's to prevent such a situation. At step 403, the audio data 170 in the audio file 110 is fingerprinted to generate a hash code “fingerprint” which uniquely identifies the track. In implementation, this may take the form of several fingerprints being generated depending on the approach used by the third-party check databases. The computed fingerprint is compared to the database 152 of fingerprints, and a check is performed at step 404 to ensure the same track is not already registered. This would indicate a potential copyright violation.

At step 405, the audio file metadata 172 is compared to metadata database entries 169 to test if the audio file 110 is being passed off as another existing popular work. In the case that this is the first-time a user has used the website for upload, the audio file may be re-queued for manual checking at step 407, based on a check at step 406. This stage may be omitted for “trusted” users at step 408. When a user has previously uploaded audio files that were not suitable, the audio file is automatically requeued for manual checks. This includes directing, based on the computed trust level of the user 114, an enqueued audio file for a manual copyright check, and rejecting, based on results received in response to the manual copyright check, the audio file as associated with an unacceptable risk of copyright infringement.

When the user 112 is trusted, a random manual check on files may be carried out. Similarly, where a user persistently abuses the service does not follow the service requirements, the ability to upload and/or sell audio files 110 is disabled for their account or their account suspended according the severity of the abuse.

If either the manual check at step 409 or any of the previous checks fail, the upload is rejected at step 410, the user informed at step 411, and the trust level 163 of the user updated at step 412. Otherwise, the audio file 110 including the required metadata 172 is processed for corresponding tags at step 413, uploaded to the distribution entity 160 ready to push to the sales endpoints 104 (e.g. to iTunes, Amazon etc.), at step 414. The distribution entity 160 is typically a pay for services network resources accessible via a public access network, although any suitable commercialization entity may be utilized.

Since the uploaded audio file 110 has now passed the copyright checks, it is acknowledged for entry into the DB 152, and a fingerprint calculated for storage in the fingerprint table 164, as shown at step 415. Relevant metadata is published at step 416, and the trust level entry 166 of the user 112 updated at step 417.

Those skilled in the art should readily appreciate that the programs and methods defined herein are deliverable to a user processing and rendering device in many forms, including but not limited to a) information permanently stored on non-writeable storage media such as ROM devices, b) information alterably stored on writeable non-transitory storage media such as floppy disks, magnetic tapes, CDs, RAM devices, and other magnetic and optical media, or c) information conveyed to a computer through communication media, as in an electronic network such as the Internet, cloud or telephone modem lines. The operations and methods may be implemented in a software executable object or as a set of encoded instructions for execution by a processor responsive to the instructions. Alternatively, the operations and methods disclosed herein may be embodied in whole or in part using hardware components, such as Application Specific Integrated Circuits (ASICs), Field Programmable Gate Arrays (FPGAs), state machines, controllers or other hardware components or devices, or a combination of hardware, software, and firmware components.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. In a music distribution environment for receiving audio files intended for retail distribution, a method of detecting ownership rights, comprising:
receiving an audio file containing audio data and metadata from a user; computing an identity token operative to designate an existence of copyrighted material in the audio data;
performing a matching operation with a database of identity tokens computed from audio data of copyrighted music tracks to identify an entry similar to the computed identity token, the database containing entries of protected tracks;
comparing the metadata with metadata corresponding to entries in the database; and
determining, based on the matching operation and metadata comparison, whether the received audio file corresponds to a protected track.

2. The method of claim 1 further comprising:
performing fingerprint matching between the audio file and the database of protected tracks;
performing fuzzy text matching of the received metadata with metadata in the database; and
determining a correspondence to a protected track if at least one of the fingerprint and the metadata indicates a match.

3. The method of claim 1 further comprising:
determining a correspondence between the received audio file and a protected track in the database based on fingerprint matching of the audio data, fuzzy text matching of titles, and matching of metadata.

4. The method of claim 3 further comprising concluding that a copyright conflict exists if an entry corresponding to the audio file is found in the database.

5. The method of claim 4 further comprising:
associating the user with a trust level, the trust level indicative of a likelihood that an audio file received from the user is found to have a corresponding entry in the database.

6. The method of claim 1 wherein the audio file further comprises a video file including an audio portion defining the audio data.

7. The method of claim 2 further comprising:
receiving a plurality of audio files, each audio files having an uploading user, the audio data in the audio file purported to be owned by the uploading user;
storing the audio file in a queue for invocation of fingerprint and metadata comparisons for determining the correspondence to a protected track; and
mapping, upon dequeueing the audio file, an encoding format of the audio data for operational compatibility with a distribution entity.

8. The method of claim 7 further comprising:
receiving, from a graphical user interface (GUI) responsive to the user, an inquiry from the uploading user, the inquiry concerning the audio file;
prior to determining correspondence to a protected track,
verifying the metadata for inclusion of tags expected by the distribution entity; and
assigning, if an identifier of the audio track is not defined, the identifier for uniquely identifying the audio track from other entries in the database.

9. The method of claim 8 wherein the tags include ID3 tags, the identifier is an ISRC identifier, and the distribution entity is a pay for services network resources accessible via a public access network.

10. The method of claim 2 wherein determining the correspondence to a protected track further comprises:
computing a fingerprint on the audio data;
performing a lookup in the database to determine if a matching fingerprint is found in the database;
performing comparisons of the title based on fuzzy text matching to identify a database entry having an alternate title spelling; and
comparing the metadata to metadata of entries in the database to identify a similar track or volume arrangement.

11. The method of claim 7 further comprising computing a trust level of the user from which the audio file was received based on:
a number and frequency of previous audio file uploads; and
a number of previously uploaded audio files found to have a correspondence to a protected track.

12. The method of claim 11 further comprising:
directing, based on the computed trust level, an enqueued audio file for a manual copyright check; and
rejecting, based on results received in response to the manual copyright check, the audio file as associated with an unacceptable risk of copyright infringement.

13. The method of claim 10 wherein the fingerprint further comprises computing a hashing function on the audio data.

14. A network server device for receiving audio files intended for retail distribution, comprising:
a user interface for receiving an audio file containing audio data and metadata from a user;
a database of identity tokens computed from audio data of copyrighted music tracks, and metadata indicative of the audio data;
a fingerprint generator for computing an identity token operative to designate an existence of copyrighted material in the audio data;
a fingerprint comparator for performing a matching operation with the database to identify an entry similar to the computed identity token, the database containing entries of protected tracks; and
a metadata comparator for comparing the metadata with metadata corresponding to entries in the database,
the server including logic for determining, based on the matching operation and metadata comparison, whether the received audio file corresponds to a protected track.

15. The device of claim 14 wherein the server is configured to:
perform fingerprint matching between the audio file and the database of protected tracks;
perform fuzzy text matching of the received metadata with metadata in the database;
determine a correspondence to a protected track if at least one of the fingerprint and the metadata indicates a match; and
conclude that a copyright conflict exists if an entry corresponding to the audio file is found in the database.

16. The device of claim 14 further comprising
a trust level associated with the user, the trust level indicative of a likelihood that an audio file received from the user is found to have a corresponding entry in the database.

17. The device of claim 15 wherein the server is further operable to:
receive a plurality of audio files, each audio files having an uploading user, the audio data in the audio file purported to be owned by the uploading user;
store the audio file in a queue for invocation of fingerprint and metadata comparisons for determining the correspondence to a protected track; and
map, upon dequeueing the audio file, an encoding format of the audio data for operational compatibility with a distribution entity.

18. The device of claim 15 wherein the server logic is configured to determine the correspondence to a protected track by:
computing a fingerprint on the audio data;
performing a lookup in the database to determine if a matching fingerprint is found in the database;
performing comparisons of the title based on fuzzy text matching to identify a database entry having an alternate title spelling; and
comparing the metadata to metadata of entries in the database to identify a similar track or volume arrangement.

19. The device of claim 16 wherein the server is operable to compute the trust level of the user from which the audio file was received based on:
a number and frequency of previous audio file uploads;
a number of previously uploaded audio files found to have a correspondence to a protected track.

20. A computer program product on a non-transitory computer readable storage medium having instructions that, when executed by a processor, perform a method of detecting ownership rights of received audio files intended for retail distribution, the method of comprising:
receiving an audio file containing audio data and metadata from a user; computing an identity token operative to designate an existence of copyrighted material in the audio data;
performing a matching operation with a database of identity tokens computed from audio data of copyrighted music tracks to identify an entry similar to the computed identity token, the database containing entries of protected tracks;
comparing the metadata with metadata corresponding to entries in the database; and
determining, based on the matching operation and metadata comparison, whether the received audio file corresponds to a protected track.
